(19) United States
(12) Patent Application Publication
(10) Pub. No.: US 2019/0302316 A1
(43) Pub. Date: Oct. 3, 2019

(54) ANTI-FOULING APPLIQUE FOR A LENS OF A SENSOR

(71) Applicant: GM Global Technology Operations LLC, Detroit, MI (US)

(72) Inventors: Adam F. Gross, Los Angeles, CA (US); Berryinne Decker, Macedonia, OH (US); Adam L. Wright, Farmington Hills, MI (US)

(73) Assignee: GM Global Technology Operations LLC, Detroit, MI (US)

(21) Appl. No.: 15/943,046

(22) Filed: Apr. 2, 2018

(51) Int. Cl. G02B 1/14; G02B 1/04; C09J 7/38; C09J 7/24

(52) U.S. Cl. CPC G02B 1/14; G02B 1/04; C09J 157/06; C09J 7/243; C09J 7/385

(57) ABSTRACT

A sensor for emitting or receiving light rays includes a clear substrate having a first surface, and an applique attached to the first surface of the clear substrate. The applique includes a transparent fluoropolymer sheet of fluorinated ethylene propylene having a first surface facing the first surface of the clear substrate, and a pressure sensitive optically clear acrylic adhesive disposed on the first surface of the fluoropolymer sheet. The pressure sensitive acrylic adhesive adheres the transparent sheet to the first surface of the clear substrate, and exhibits a peel strength of between 1 and 3 lbs/in. The first surface of the fluoropolymer sheet is treated for adhesion prior to applying the pressure sensitive acrylic adhesive thereto.

### INTRODUCTION

The disclosure generally relates to a transparent applique for covering a lens of a sensor.

Light emitting and/or receiving sensors may be located outside, and exposed to harsh environmental conditions. For example, many vehicles include light emitting and receiving sensors, such as but not limited to, cameras, LIDAR sensors, rangefinders, etc., which are positioned on the exterior of the vehicle and exposed to the elements. Light emitting and/or receiving sensors include a lens through which light rays must pass. The exterior surface of the lens must be protected from scratches and kept clean of dirt and debris in order to maintain light transmission through the lens for proper functionality of the sensor.

### SUMMARY

An applique for covering a clear substrate that emits and/or receives light rays therethrough is provided. The applique includes a transparent sheet having a first surface configured to face a first surface of the clear substrate, and a pressure sensitive adhesive. The pressure sensitive adhesive is disposed on the first surface of the transparent sheet, and adheres the transparent sheet to the first surface of the clear substrate.

In one aspect of the applique, the transparent sheet is a fluoropolymer. In one embodiment, the transparent sheet is fluorinated ethylene propylene (FEP). However, in other embodiments, the transparent sheet may include, but is not limited to, Ethylene tetrafluoroethylene (EFTE), Perfluoroalkoxy alkane (PFA), amorphous fluoroplastics (AF), or an alternating copolymer of ethylene and tetrafluoroethylene (EFEP).

In one aspect of the applique, the transparent sheet includes a thickness between 10 and 200 microns. In another aspect of the applique, the transparent sheet exhibits a peel strength between 0.5 and 3.0 pounds per inch. As such, the transparent sheet may be peeled off the clear substrate, and replaced with a new transparent sheet.

In one aspect of the applique, the pressure sensitive adhesive includes a linear or branched, random or blocked, polymer, having one, two, three, or more monomer units. In another aspect of the applique, the pressure sensitive adhesive is a dry adhesive. In one embodiment of the applique, the pressure sensitive adhesive is an acrylic adhesive, such as but not limited to optically clear adhesive 8172 from the 3M™ Corporation.

In one aspect of the applique, the first surface of the transparent sheet is treated for adhesion. The first surface of the transparent sheet may be treated for adhesion using one of an ozone treating process, a corona treating process, a chemical etching process, or a plasma treating process.

In another aspect of the applique, the applique may be pre-assembled with a removable release liner disposed over the pressure sensitive adhesive. The release liner may be peeled off, and the applique applied to the first surface of the clear substrate.

A sensor is also provided. The sensor includes an electronic sensing unit that is operable to emit or receive light rays. For example, the electronic sensing unit may include, but is not limited to, a LIDAR unit, a rangefinder, a camera, etc. A clear substrate is attached to the electronic sensing unit, and has a first surface. The first surface of the clear substrate is non-planar and operable for concentrating or dispersing light rays. An applique is adhered to the first surface of the clear substrate. The applique includes a fluoropolymer sheet having a first surface facing the first surface of the clear substrate. An acrylic adhesive is disposed on the first surface of the transparent sheet, with the acrylic adhesive adhering the transparent sheet to the first surface of the clear substrate.

In one aspect of the sensor, the clear substrate is one of a glass material or a plastic material. For example, the clear substrate may include, but is not limited to silica, borosilicate glass, quartz, polycarbonate Trivex by PPG™, CR-39 plastic, crown glass, etc. In another aspect of the sensor, the first surface of the clear substrate is a non-planar surface. For example, the first surface of the clear substrate may include a convex surface, or a concave surface.

Accordingly, the applique covers and protects the clear substrate of the sensor. The transparent fluoropolymer sheet provides anti-fouling properties that shed dirt and water to maintain light transmission through the clear substrate, as well as protect the clear substrate from scratches. The pressure sensitive adhesive provides sufficient adhesion to keep the transparent sheet adhered to the clear substrate, yet exhibits a peel strength that enables easy removal of the transparent sheet for replacement with a new transparent sheet, without damaging the clear substrate. The pressure sensitive adhesive is environmentally stable, such that it does not degrade and reduce light transmission from UV light exposure. Additionally, the pressure sensitive adhesive maintains adhesion when exposed to solvents, such as window washing fluid.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic partially exploded cross sectional view of a sensor.

FIG. 2 is a schematic cross sectional view of the sensor, showing an applique positioned over a clear substrate.

FIG. 3 is a schematic perspective view of the applique showing a release liner partially removed.

FIG. 4 is a chart showing the relationship between a percent light transmission at different wavelengths through a glass substrate and a variety of glass substrates covered with an applique of fluorinated ethylene propylene (FEP) using different pressure sensitive adhesives.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

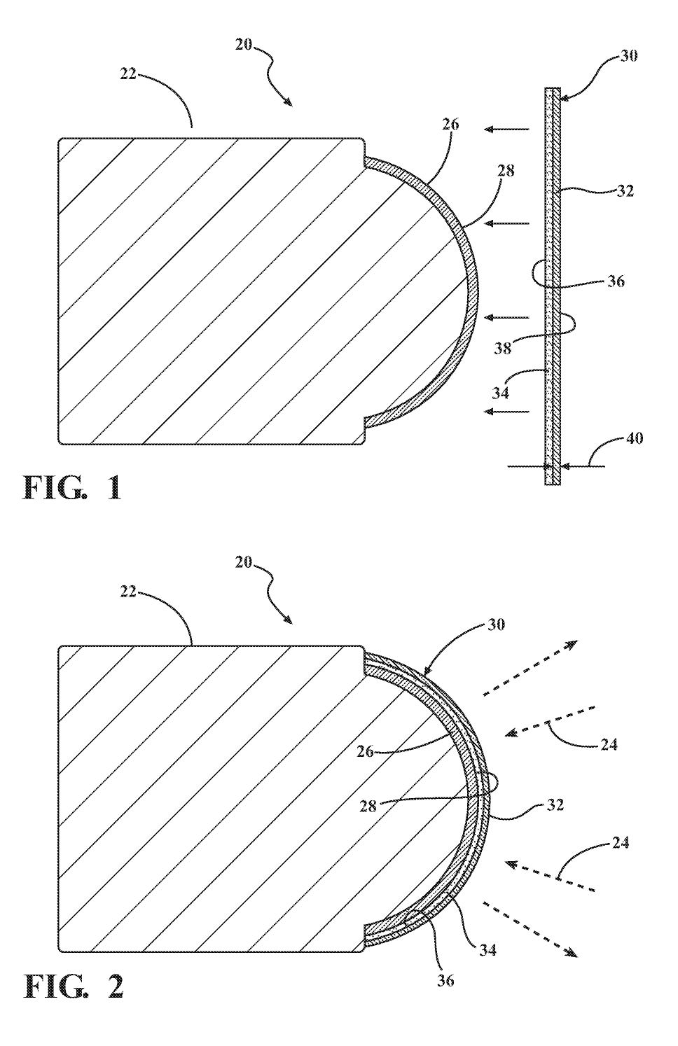

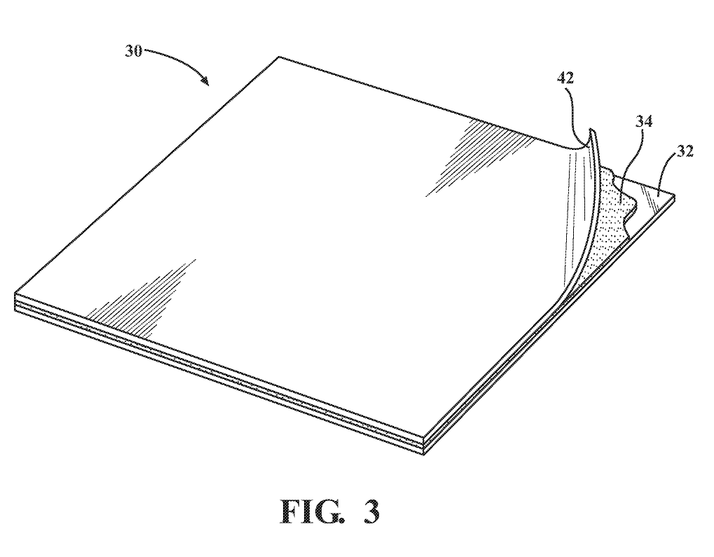

Referring to the FIGS., wherein like numerals indicate like parts throughout the several views, a sensor is generally shown at 20. Referring to FIGS. 1 and 2, the sensor 20 includes an electronic sensing unit 22 that is operable to emit and/or receive light rays 24 (shown in FIG. 2). The electronic sensing unit 22 may be configured, for example, as a range finder, a LIDAR sensor 20, a camera, or some other type of sensing device. The particular type, function and operation of the electronic sensing unit 22 is not pertinent to the teachings of this disclosure, and are therefore not described in detail herein.

The sensor 20 further includes a clear substrate 26, which is attached to the electronic sensing unit 22. As noted above, the electronic sensing unit 22 emits and/or receives light rays 24. The light rays 24 pass through the clear substrate 26. The clear substrate 26 may alternatively be referred to as a lens, a window, a pane, a panel, etc. The clear substrate 26 may be configured to concentrate or disperse the light rays 24 as the light rays 24 pass through the clear substrate 26. The clear substrate 26 includes a first surface 28. The first surface 28 of the clear substrate 26 may be considered an exterior or outer surface of the clear substrate 26. In the exemplary embodiment shown in the Figures and described herein, the first surface 28 of the clear substrate 26 is a non-planar surface. For example, the first surface 28 of the clear substrate 26 may include a concave surface of a convex surface, such as shown in the Figures. However, in other embodiments, the first surface 28 of the clear substrate 26 may include a planar surface. As is understood by those skilled in the art, the non-planar shape of the first surface 28 of the clear substrate 26 controls the concentration or dispersion of light rays 24 passing through the clear substrate 26.

The clear substrate 26 is a transparent material. The clear substrate 26 may include and be manufactured from, but is not limited to, one of a glass material or a plastic material. For example, the clear substrate 26 may include and be manufactured from silica, borosilicate glass, quartz, polycarbonate Trivex by PPG™, CR-39 plastic, crown glass, or some other suitable transparent material.

The sensor 20 includes an applique 30, which is adhered to the first surface 28 of the clear substrate 26. FIG. 1 shows the applique 30 prior to being adhered to the clear substrate 26. FIG. 2 shows the applique 30 adhered to the clear substrate 26. Referring to FIGS. 1 and 2, the applique 30 includes a transparent sheet 32, and a pressure sensitive adhesive 34. As used herein, the term “sheet” is defined as a broad, thin piece of a solid material formed into a self-supporting layer. As used herein, the term “sheet” does not include a layer or film formed from a dried liquid. The exemplary embodiment described herein includes the applique 30 adhered to the clear substrate 26 of the sensor 20. However, in other embodiments, the applique 30 may be adhered to other clear substrates 26, such as window panels for example.

Referring to FIGS. 1 and 2, the transparent sheet 32 includes a first surface 36 and an opposing second surface 38. The first surface 36 of the transparent sheet 32 faces the first surface 28 of the clear substrate 26. The second surface 38 of the transparent sheet 32 faces outward, and is exposed to the environment. Referring to FIG. 2, the transparent sheet 32 includes a thickness 40. In the exemplary embodiment described herein, the thickness 40 of the transparent sheet 32 is between 10 and 200 microns. However, in other embodiments, the thickness 40 of the transparent sheet 32 may vary from the exemplary range provided herein.

The transparent sheet 32 may include, but is not limited to, a fluoropolymer. For example, in one exemplary embodiment, the transparent sheet 32 is fluorinated ethylene propylene (FEP). However, the transparent sheet 32 may include and be manufactured from other fluoropolymers, such as but not limited to Ethylene tetrafluoroethylene (EFTE), Perfluoroalkoxy alkane (PFA), amorphous fluoroplastics (AF), or an alternating copolymer of ethylene and tetrafluoroethylene (EFEP).

The first surface 36 of the transparent sheet 32 is treated to improve adhesion. As used herein, the phrase “treating for adhesion” is defined as using a process to clean and prepare a surface to increase surface adhesion. The first surface 36 of the transparent sheet 32 may be treated for adhesion using a suitable process. For example, the first surface 36 of the transparent sheet 32 may be treated for adhesion using one of an ozone treating process, a corona treating process, a chemical etching process, or a plasma treating process. The above noted exemplary processes for treating for adhesion are well known to those skilled in the art, and are therefore not described in detail herein.

The pressure sensitive adhesive 34 is disposed on the first surface 36 of the transparent sheet 32, which was previously treated for adhesion. The pressure sensitive adhesive 34 adheres the transparent sheet 32 to the first surface 28 of the clear substrate 26. The pressure sensitive adhesive 34 includes a distinct category of adhesive materials that in a dry form (e.g., substantially free of both water and solvent) is permanently tacky at room temperature, firmly adheres to a variety of dissimilar surfaces at room temperature upon mere contact without the need of more than 20 pounds per square inch of pressure being applied. The pressure sensitive adhesive 34 may include a linear or branched, random or blocked, polymer, having one, two, three, or more monomer units. Exemplary pressure sensitive adhesives 34 can include a material chosen from the adhesives of acrylic resin, polyurethane, rubber, styrene-butadiene-styrene copolymers, ethylene vinyl acetate, styrene block copolymers, polyisobutene (PIB) and silicone, and combinations thereof, such as styrene-ethylene/butylene-styrene (SEBS) block copolymer, styrene-ethylene/propylene (SEP) block copolymer, styrene-isoprene-styrene (SIS) block copolymer, or combinations thereof. Notably, the pressure sensitive adhesive 34 does not form a chemical bond with either the transparent sheet 32 or the clear substrate 26.

In the exemplary embodiment described herein, the pressure sensitive adhesive 34 is a dry adhesive. As such, once applied to the first surface 36 of the transparent sheet 32 and readied for application onto the first surface 28 of the clear substrate 26, the pressure sensitive adhesive 34 is substantially free of water and solvent. In one exemplary embodiment, the pressure sensitive adhesive 34 is an acrylic adhesive. For example, the pressure sensitive adhesive 34 may include optically clear adhesive 8172 from the 3M™ Corporation.

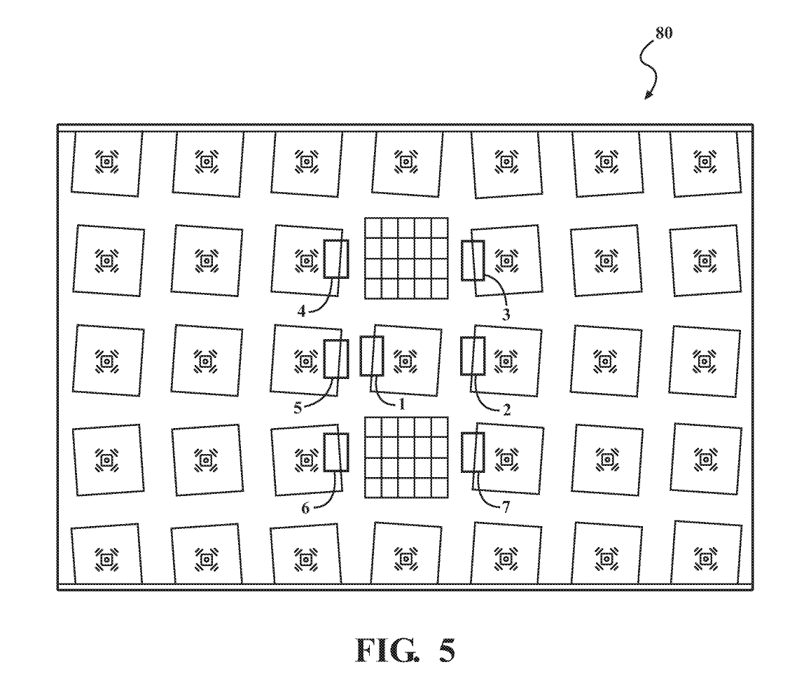

The clear substrate 26 exhibits an index of refraction. As understood by those skilled in the art, the “index of refraction” of a material is a dimensionless number that describes how light propagates through that material. The pressure sensitive adhesive 34 and the transparent sheet 32 also exhibit a respective index of refraction. In an exemplary embodiment, the materials used for the clear substrate 26, the pressure sensitive adhesive 34, and the transparent sheet 32 may be selected such that the index of refraction of the transparent sheet 32 is less than the index of refraction of the pressure sensitive adhesive 34. Additionally, the index of refraction of the pressure sensitive adhesive 34 may be less than the index of refraction of the clear substrate 26. By configuring the transparent sheet 32, the pressure sensitive adhesive 34, and the clear substrate 26 in this manner, i.e., with the index of refraction of the transparent less than the index of refraction of the pressure sensitive adhesive 34, which is less than the index of refraction of the clear substrate 26, the transparent sheet 32 and the pressure sensitive adhesive 34 act as an anti-reflection layer for the clear substrate 26, thereby improving light transmission through the clear substrate 26. This improved light transmission through the clear substrate 26 is generally shown in FIG. 4. Referring to FIG. 4, the percent light transmission through the clear substrate 26 is generally indicated along a vertical axis 50, with the wavelength of the light generally indicated along a horizontal axis 52. A first line 54 shows light transmission through the clear substrate 26, with no applique attached. A second line 56 shows light transmission through the clear substrate 26, having a transparent sheet 32 of FEP and a pressure sensitive adhesive 8171 from the 3M™ Corporation. A third line 58 shows light transmission through the clear substrate 26, having a transparent sheet 32 of FEP, and a pressure sensitive adhesive 8172 from the 3M™ Corporation. A fourth line 60 shows light transmission through the clear substrate 26, having a transparent sheet 32 of FEP, and a pressure sensitive adhesive 8262N from the 3M™ Corporation. In the Exemplary embodiments tested, all of the appliques 30 had lower indices of refraction than glass, and thus show higher percent transmission due to acting as anti-reflection layers. However, in other embodiments, the index of refraction of the transparent sheet 32, the pressure sensitive adhesive 34, and the clear substrate 26 may be configured differently than described above. For example, the index of refraction of the transparent sheet 32, the pressure sensitive adhesive 34, and the clear substrate 26 may be substantially equal.

In order to assemble the sensor 20, the applique 30 must first be prepared. Preparation of the applique 30 includes treating the first surface 36 of the transparent sheet 32 to improve adhesion. As described above, the first surface 36 of the transparent sheet 32 may be treated for adhesion in a suitable manner, including but not limited to, an ozone treating process, a corona treating process, a chemical etching process, or a plasma treating process. The first surface 36 of the transparent sheet 32 is treated for adhesion to improve the adhesion between the pressure sensitive adhesive 34 and the transparent sheet 32. Once the first surface 36 of the transparent sheet 32 has been treated for adhesion, the pressure sensitive adhesive 34 is applied to the first surface 36 of the transparent sheet 32. The manner in which the pressure sensitive adhesive 34 is applied to the first surface 36 of the transparent sheet 32 is dependent upon the properties of the pressure sensitive adhesive 34. For example, the pressure sensitive adhesive 34 may be applied as a sheet, or may be applied in a liquid solution, and allowed to dry in order to form a film of the pressure sensitive adhesive 34. Optionally, if the applique 30 is not going to be applied to the first surface 28 of the clear substrate 26 immediately, a release liner 42 may be applied over the pressure sensitive adhesive 34 to protect the pressure sensitive adhesive 34 until the applique 30 is ready to be applied to the clear substrate 26. The release liner 42 may include a sheet of material that is easily removable from the pressure sensitive material, and that does not damage or disrupt the pressure sensitive adhesive 34 on the first surface 36 of the transparent sheet 32.

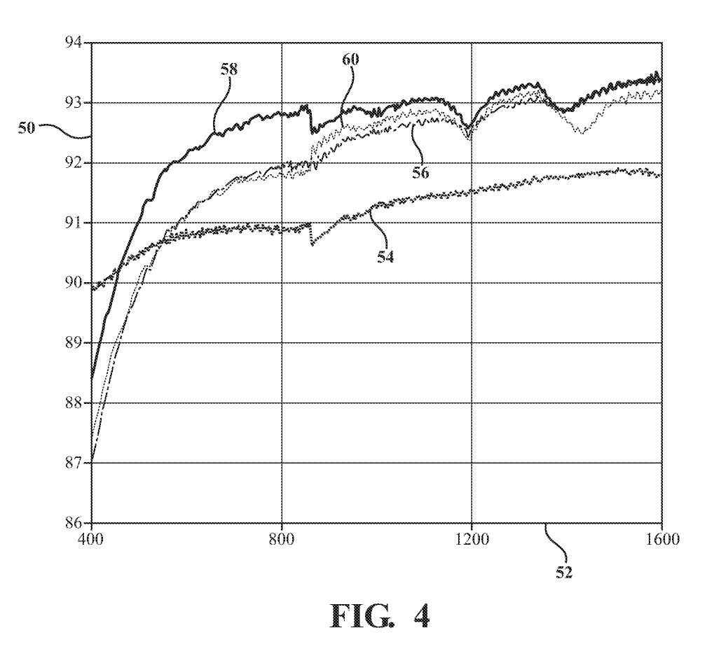

Once the applique 30 has been prepared, it is then applied to the first surface 28 of the clear substrate 26. If the applique 30 was prepared with the release liner 42, then the release liner 42 may be peeled off to expose the pressure sensitive adhesive 34, such as shown in FIG. 3. The transparent sheet 32 is then positioned on the first surface 28 of the clear substrate 26, such as shown in FIG. 2, with the pressure sensitive adhesive 34 contacting the first surface 28 of the clear substrate 26. In some embodiments, and depending upon the specific characteristics of the pressure sensitive adhesive 34, a liquid, such as water, may be applied to the first surface 28 of the clear substrate 26 prior to positioning the transparent sheet 32 on the first surface 28 of the clear substrate 26. The liquid, in some circumstances, may allow the transparent sheet 32 to be shifted into a proper position, and/or allow air bubbles and wrinkles in the transparent sheet 32 to be worked out. Once the transparent sheet 32 is properly positioned on the clear substrate 26, sufficient pressure may be applied to the transparent sheet 32 to create the adhesion between the pressure sensitive adhesive 34 and the first surface 28 of the clear substrate 26. Once applied to the clear substrate 26, the transparent sheet 32 exhibits a peel strength of between 0.5 and 3.0 pounds per inch.

At regular maintenance intervals, the transparent sheet 32 may be easily removed from the clear substrate 26, and a new applique 30 applied therein. In so doing, the sensor 20 may maintain a clear, clean, protective surface over the clear substrate 26. The transparent fluoropolymer sheet of the applique 30, e.g., fluorinated ethylene propylene, in combination with the acrylic pressure sensitive adhesive 34, provide good light transmission through the clear substrate 26, do not degrade in response to UV exposure, maintain proper adhesion even when exposed to lens cleaning solvents such as window washer fluid, and easily shed dirt and other debris to keep the clear substrate 26 clean and protected.

Testing was conducted on exemplary embodiments. Fluorinated ethylene propylene (FEP) appliques were fabricated with a range of pressure sensitive adhesives (PSA) to provide a removable anti-soiling solution for sensors. Optical transparency, peel strength, UV exposure, methanol resistance, camera resolution, and LIDAR attenuation were tested. FEP appliques using acrylic adhesive 8172 from the 3M™ Corporation, optical grade, outdoor rated PSA performed best across all measurements. These appliques improved the light transmission on glass substrates due to their lower index of refraction compared to silica and lost 2-6% of light on polycarbonate LIDAR lenses. Appliques of FEP on acrylic adhesive 8172 from the 3M™ Corporation maintained a 2±0.5 lb/in peel strength from 20° F. to 120° F. demonstrating they were removable but would not fall off from temperature variations. After a 3 month equivalent UV exposure, the applique transmission decreased by a negligible 0.5% and there was no change in anti-fouling results. FEP on acrylic adhesive 8172 from the 3M™ Corporation did not de-bond off glass after 7 days soak in methanol or lose transparency, which indicates that these appliques will not be removed or degraded by sensor fluidic wash systems.

The resolution of a DSLR camera was tested with and without appliques on the lens surface by capturing images of test charts and measuring the mean transfer function (MTF). The MTF is the contrast at a given spatial frequency (f) relative to contrast at low frequencies (large areas). Spatial frequency is typically measured in black and white cycles per pixel or line pairs per millimeter (lp/mm). The theoretical highest MTF is 0.5 cycles per pixel because this corresponds to one black pixel next to one white pixel. MTF50, or the cycles per pixel where the contrast was 50% of the contrast of a large black versus large white section, was measured and the average results for seven different locations on the test charts, for two different FEP/PSA appliques and a bare camera lens, are shown in Table 1 below.

TABLE 1

| | Ave. Cycles/Pixel |
|---|---|
| Sample | at MTF50 ± 1S.D. |
| Bare Camera Lens | 0.393 ± 0.008 |
| FEP/8172 by 3M ™ Corp. on Camera Lens | 0.387 ± 0.018 |
| FEP/8262N by 3M ™ Corp. on Camera Lens | 0.373 ± 0.008 |

The standard deviation of the applique made of FEP on acrylic adhesive 8172 by 3M™ Corporation, on the Camera Lens, overlaps with the values for the Bare Camera Lens. In contrast, the standard deviation of the applique made of FEP on adhesive 8262N by 3M™ Corporation, on the Camera Lens, does not overlap with the Bare Camera Lens, and appears to reduce the camera resolution.

To validate the differences, an ANOVA analysis was performed on the data set to determine if the results are statistically significant. The ANOVA analysis predicts the probability that two data sets are distinct, however, the error rate increases with multiple comparisons because of the greater chance of one incorrect result. For example, the error probability is magnified by 1−(1−p)ⁿ; p is the pairwise error limit and n is the number of comparisons. For 3 comparisons, there is a 1−(1−0.05)³=0.1426 or 14% change of a false positive with p=0.05 (95% confidence level). To rectify this issue we adjust individual p values based on p=1−(1−a)^{1/n} where a is p value for the full set of comparisons and n is the number of comparisons. The 95% confidence interval is reached at p≤1−(1-0.05)^{1/3}≤0.017 for this set. The ANOVA analysis results are shown in Table 2 below.

TABLE 2

| | | | P vs. FEP/ |
|---|---|---|---|
| | | | 8172 by 3M ™ |
| | | ρ vs. Bare | Corp. on |
| | Ave. Cycles/Pixel | Camera | Camera |
| Sample | at MTF50 ± 1S.D. | Lens | Lens |
| Bare Camera Lens | 0.393 ± 0.008 | — | — |
| FEP/8172 by 3M ™ | 0.387 ± 0.018 | 0.5000 | — |
| Corp. on Camera Lens | | (Not | |
| | | Distinct) | |
| FEP/8262N by 3M ™ | 0.373 ± 0.008 | 0.0007 | 0.0787 |
| Corp. on Camera Lens | | (Distinct) | (Not |
| | | | Distinct) |

The ANOVA analysys results show that the applique made from FEP using adhesive 8172 by 3M™ Corporation is not distinct from the Bare Camera Lens, thus there is no decrease in camera resolution from applying the applique onto the camera lens. However the applique made from FEP using adhesive 8262N by 3M™ Corporation is distinct from the Bare Camera Lens and the decrease in resolution from this applique is statistically significant.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. An applique for covering a clear substrate that emits and/or receives light rays therethrough, the applique comprising:
a transparent sheet having a first surface configured to face a first surface of the clear substrate; and
wherein the transparent sheet includes a pressure sensitive adhesive disposed on the first surface of the transparent sheet, with the pressure sensitive adhesive operable to adhere the transparent sheet to the clear substrate.

2. The applique set forth in claim 1, wherein the transparent sheet is a fluoropolymer.

3. The applique set forth in claim 2, wherein the transparent sheet is fluorinated ethylene propylene.

4. The applique set forth in claim 1, wherein the pressure sensitive adhesive includes a linear or branched, random or blocked, polymer, having at least one monomer unit.

5. The applique set forth in claim 4, wherein the pressure sensitive adhesive is a dry adhesive.

6. The applique set forth in claim 1, wherein the pressure sensitive adhesive is an acrylic adhesive.

7. The applique set forth in claim 1, wherein the first surface of the transparent sheet is treated for adhesion.

8. The applique set forth in claim 7, wherein treated for adhesion includes one of an ozone treating process, a corona treating process, a chemical etching process, or a plasma treating process.

9. The applique set forth in claim 1, wherein the transparent sheet includes a thickness between 10 and 200 microns.

10. The applique set forth in claim 1, wherein the transparent sheet exhibits a peel strength between 0.5 and 3.0 pounds per linear inch.

11. The applique set forth in claim 1, wherein the clear substrate exhibits an index of refraction, the pressure sensitive adhesive exhibits an index of refraction, and the transparent sheet exhibits an index of refraction, with the index of refraction of the transparent sheet being less than the index of refraction of the pressure sensitive adhesive, and with the index of refraction of the pressure sensitive adhesive being less than the index of refraction of the clear substrate.

12. A sensor comprising:
an electronic sensing unit operable to emit and/or receive light rays;
a clear substrate attached to the electronic sensing unit and having a first surface, wherein the first surface of the clear substrate is non-planar and operable for concentrating or dispersing light rays;
an applique adhered to the first surface of the clear substrate, the applique including:
a fluoropolymer sheet having a first surface facing the first surface of the clear substrate; and
an acrylic adhesive disposed on the first surface of the transparent sheet, with the acrylic adhesive adhering the transparent sheet to the first surface of the clear substrate.

13. The sensor set forth in claim 12, wherein the fluoropolymer sheet is fluorinated ethylene propylene having a thickness between 10 and 200 microns

14. The sensor set forth in claim 12, wherein the clear substrate exhibits an index of refraction, the acrylic adhesive exhibits an index of refraction, and the fluoropolymer sheet exhibits an index of refraction, with the index of refraction of the fluoropolymer sheet being less than the index of refraction of the acrylic adhesive, and with the index of refraction of the acrylic adhesive being less than the index of refraction of the clear substrate.

15. The sensor set forth in claim 12, wherein the first surface of the fluoropolymer sheet is treated for adhesion with one of an ozone treating process, a corona treating process, a chemical etching process, or a plasma treating process.

16. The sensor set forth in claim 12, wherein the first surface of the clear substrate is a non-planar surface.

17. The sensor set forth in claim 12, wherein the clear substrate is one of a glass material or a plastic material.

18. An applique for covering a lens of a sensor, the applique comprising:
a fluoropolymer sheet having a first surface treated for adhesion;
an acrylic adhesive disposed on the first surface of the transparent sheet; and
a removable release liner disposed over the acrylic adhesive.

19. The applique set forth in claim 18, wherein the fluoropolymer sheet is fluorinated ethylene propylene having a thickness between 10 microns and 200 microns.

20. The applique set forth in claim 18, wherein the first surface of the fluoropolymer sheet is treated for adhesion with one of an ozone treating process, a corona treating process, a chemical etching process, or a plasma treating process.
